(19) United States
(12) Patent Application Publication
(10) Pub. No.: US 2025/0289375 A1
(43) Pub. Date: Sep. 18, 2025

(54) WORK VEHICLE

(71) Applicant: Kubota Corporation, Osaka-shi (JP)

(72) Inventors: Tatsuya YAMAGUCHI, Sakai-shi (JP); Takefumi OGURI, Sakai-shi (JP); Naoto MANTOKU, Sakai-shi (JP); Haruki MITSUI, Sakai-shi (JP)

(21) Appl. No.: 19/223,771

(22) Filed: May 30, 2025

Related U.S. Application Data
(63) Continuation of application No. PCT/JP2023/031401, filed on Aug. 30, 2023.

(30) Foreign Application Priority Data
Dec. 27, 2022 (JP) 2022-210898

(51) Int. Cl. B60R 11/02; B60R 11/00; B60R 16/02

(52) U.S. Cl. CPC B60R 11/02; B60R 16/0207; B60R 2011/0012; B60Y 2200/221

(57) ABSTRACT

A work vehicle includes a traveling device, a vehicle body supported by the traveling device, and a communication module configured or programmed to transmit information on the vehicle body to an outside. A least a portion of the communication module is exposed from the vehicle body to the outside.

### CROSS REFERENCE TO RELATED APPLICATIONS

This application claims the benefit of priority to Japanese Patent Application No. 2022-210898 filed on Dec. 27, 2022 and is a Continuation Application of PCT Application No. PCT/JP2023/031401 filed on Aug. 30, 2023. The entire contents of each application are hereby incorporated herein by reference.

### BACKGROUND OF THE INVENTION

### 1. Field of the Invention

The present invention relates to work vehicles each including a communication module to transmit information of a vehicle body to outside.

### 2. Description of the Related Art

Japanese Patent Application Laid-Open No. 2020-19353 (JP 2020-19353 A) discloses a passenger work vehicle in which a communication device that transmits information collected by the passenger work vehicle to a management center or the like at a remote location is provided inside a hood.

### SUMMARY OF THE INVENTION

In a case where the communication device is described in Japanese Patent Application Laid-Open No. 2020-19353 (JP 2020-19353 A), since the communication device is inside the hood, the communication device is protected by the hood, but there is a possibility that a communication state is degraded due to the attenuation of electromagnetic waves, and there is a possibility that measures such as increasing the intensity of the electromagnetic waves are required.

Example embodiments of the present invention provide work vehicles in each of which a communication module including a simple configuration is installed at a location where a communication state is good.

A work vehicle according to an example embodiment of the present invention includes a traveling device, a vehicle body supported by the traveling device, and a communication module configured or programmed to transmit information on the vehicle body to an outside, in which at least a portion of the communication module is exposed from the vehicle body to the outside.

According to the present configuration, since at least a portion of the communication module is exposed from the vehicle body to the outside, it is possible to improve a communication state of the communication module. That is, the communication module is able to be installed in the work vehicle while the communication state is good.

In an example embodiment of the present invention, the communication module and the vehicle preferably do not overlap with each other from above.

According to the present configuration, it is possible to further improve the communication state of the communication module.

In an example embodiment of the present invention, the vehicle body preferably includes a driving section including a driving seat, and the communication module is preferably located rearward of the driving seat.

Depending on the installation location of the communication module, a field of view of the driver may be obstructed during driving. According to the present configuration, since the communication module is located rearward of the driving seat, the field of view of the driver is not obstructed during driving.

In an example embodiment of the present invention, an outer end portion of the communication module is preferably located outward of an outer end portion of the driving seat in a vehicle body right-left direction.

According to the present configuration, the driving seat is less likely to hinder the communication of the communication module, and it is possible to improve the communication state of the communication module.

In an example embodiment of the present invention, the work vehicle preferably further includes a controller provided in the driving section, and a wire harness configured to connect the controller and the communication module, in which the controller is preferably provided forward of the communication module, the wire harness preferably extends from the controller to the rear side of the driving seat below the driving section, and is preferably connected to the communication module, a connector is preferably provided in a portion of the wire harness that is located rearward of the driving section, and the wire harness is preferably separable into a portion on a controller side and a portion on a communication module side.

According to the present configuration, the wire harness that connects the controller and the communication module spaced apart from each other in the front and rear is able to be arranged without being exposed to the outside by using the space below the driving section, and since the connector is provided at a position (rear portion of the driving section) which is easy to access from the rear of the vehicle body and close to the communication module, it is possible to improve workability when detaching the communication module.

In an example embodiment of the present invention, the vehicle body preferably includes a driving section and a ROPS surrounding the driving section, the ROPS preferably includes right and left vertical structures installed upright at both right and left end portions of the driving section, and a lateral structure is connected upper end portions of the right and left vertical structures, and the communication module is preferably provided between the right and left vertical structures.

According to the present configuration, for example, even in a case where a side portion of the vehicle body on a side comes into contact with an obstacle, the communication module is able to be protected by the ROPS.

In an example embodiment of the present invention, the vehicle body preferably includes right and left fenders covering the traveling device, and a connecting structure is connected the right and left fenders, and the communication module is preferably provided on the connecting structure.

According to the present configuration, since the connecting structure connecting the right and left fenders is a stable structure, the communication module is able to be supported in a stable state without providing a dedicated support structure.

In an example embodiment of the present invention, the communication module preferably includes an antenna configured to transmit the information on the vehicle body to the outside, and the antenna and the connecting structure preferably do not overlap in a planar manner.

According to the present configuration, an effect of the connecting structure on the communication state of the antenna is able to be kept low.

In an example embodiment of the present invention, the vehicle body preferably includes a driving section and a ROPS surrounding the driving section, the ROPS preferably includes right and left vertical structures installed upright at both right and left end portions of the driving section, and a lateral structure is connected upper end portions of the right and left vertical structures, and the communication module is preferably provided on the lateral structure.

According to the present configuration, since the lateral structure is present at a high position and there is no obstacle around the lateral structure, it is possible to improve the communication state of the communication module.

In an example embodiment of the present invention, the vehicle body preferably includes a driving section including a driving seat, and the communication module is preferably provided at a position not interfering with a range of work performed by a hand of a driver seated on the driving seat.

According to the present configuration, the human body of the driver is unlikely to affect the communication of the communication module, and the driver is unlikely to be affected by the communication electromagnetic waves of the communication module.

In an example embodiment of the present invention, the communication module preferably includes an information acquirer configured or programmed to acquire the information on the vehicle body, and a communicator configured or programmed to transmit the information on the vehicle body to an outside, and the communicator preferably vertically overlaps with the information acquirer and is located above the information acquirer.

According to the present configuration, the communicator and the information acquirer are able to be compactly positioned in a planar manner, the information acquirer is less likely to cause a failure in the communication state of the communicator, and it is possible to improve the communication state of the communication module.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a right side view of a work vehicle.

FIG. 2 is a plan view of the work vehicle.

FIG. 3 is a rear view of the work vehicle.

FIG. 4 is a plan view illustrating a maximum work range of arms of a driver.

FIG. 5 is a block diagram illustrating a communication configuration of vehicle body information.

FIG. 6 is a rear view illustrating an attachment structure of a communication module.

FIG. 7 is a bottom view illustrating the attachment structure of the communication module.

FIG. 8 is a perspective view illustrating a configuration of the communication module.

FIG. 9 is a right side view illustrating another example of the work vehicle according to another example embodiment of the present invention.

FIG. 10 is a front view illustrating the other example of the work vehicle according to another example embodiment of the present invention.

FIG. 11 is a right side view illustrating the other example of the work vehicle according to another example embodiment of the present invention.

FIG. 12 is a front view illustrating the other example of the work vehicle according to another example embodiment of the present invention.

### DETAILED DESCRIPTION OF THE EXAMPLE EMBODIMENTS

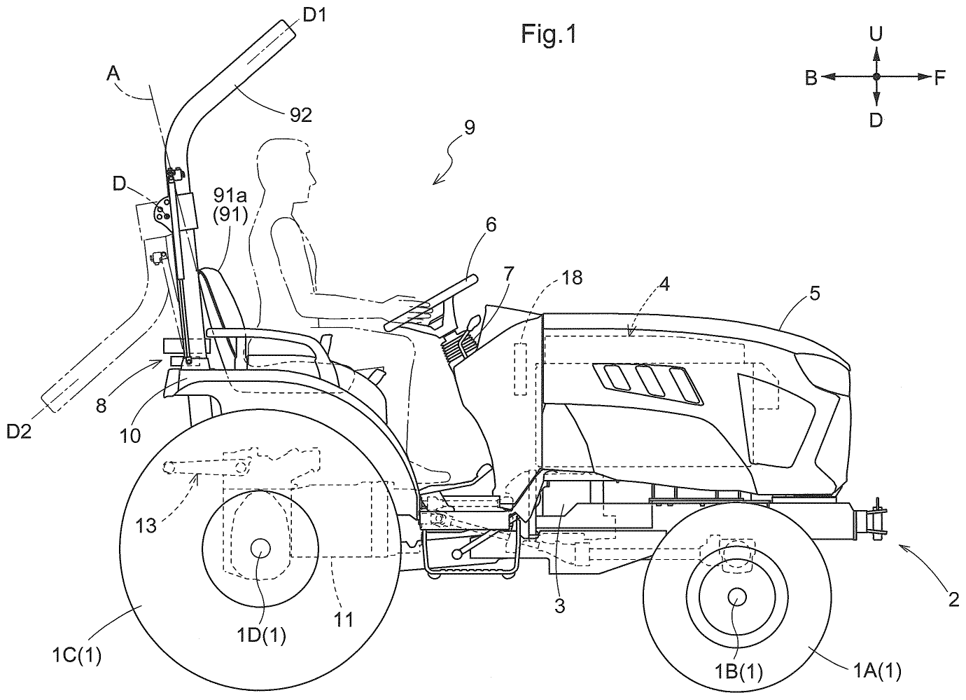

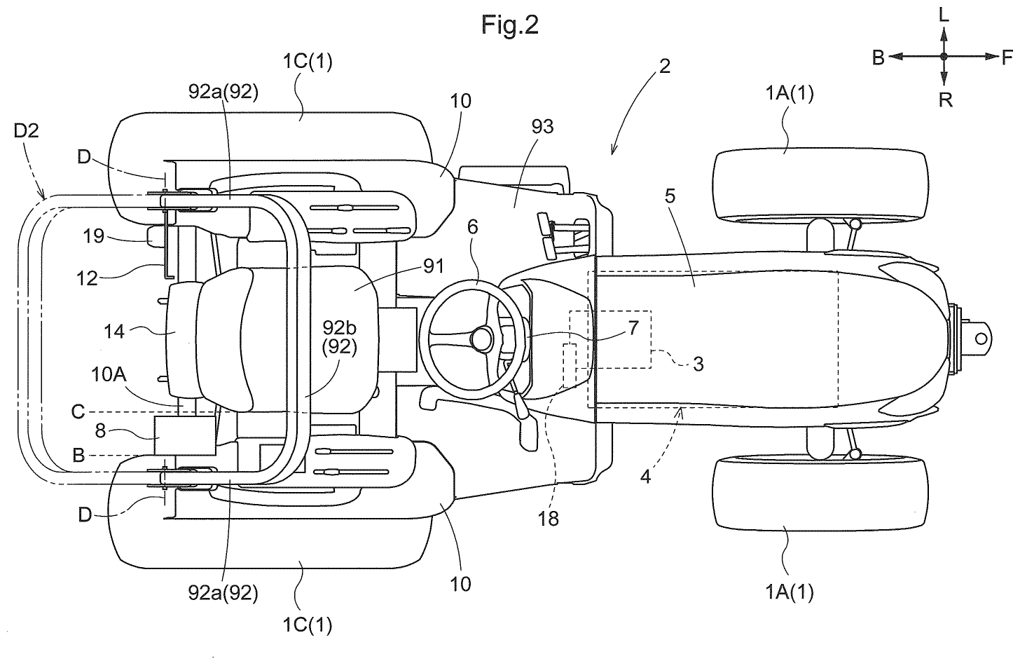

Hereinafter, tractors, which are examples of work vehicles according to example embodiments of the present invention, will be described based on the description of the drawings. In the description of the example embodiments, a front-rear direction and a right-left direction are described as follows unless otherwise specified. That is, a movement direction (see an arrow F in FIGS. 1, 2, 7, 9, and 11) on a forward side during work traveling of the work vehicle of the example embodiments is “forward”, a movement direction (see an arrow B in FIGS. 1, 2, 7, 9, and 11) on a backward side is “backward”, a direction (see an arrow R in FIGS. 2, 3, 6, 7, 10, and 12) corresponding to a right side with reference to a forward posture in the front-rear direction is “right”, and similarly, a direction (see an arrow L in FIGS. 2, 3, 6, 7, 10, and 12) corresponding to a left side is “left”. Similarly, a direction corresponding to an upper side (see an arrow U in FIGS. 1, 3, 6, 9, 10, 11, and 12) is “up”. Similarly, a direction corresponding to a lower side (see an arrow D in FIGS. 1, 3, 6, 9, 10, 11, and 12) is “down”.

As illustrated in FIGS. 1 and 2, the work vehicle is an electric tractor that travels by electric power. The work vehicle includes a traveling device 1 and a vehicle body 2 supported by the traveling device 1.

The vehicle body 2 includes a battery 4, an electric motor 3 that is driven by electric power supplied from the battery 4 and drives the traveling device 1, a transmission 11 that transmits power transmitted from the electric motor 3 to the traveling device 1 by shifting the power, a hood 5 that is provided at a front portion of the vehicle body 2 and accommodates the battery 4, and a driving section 9 that is provided behind the hood 5 and is occupiable by a driver. The electric motor 3 is provided below the hood 5, and the transmission 11 is provided below the driving section 9. An inverter that converts a direct current from the battery 4 into an alternating current is provided in the vicinity of the battery 4, and is not particularly illustrated.

The traveling device 1 includes right and left front wheels 1A, a front axle 1B connecting the right and left front wheels 1A, right and left rear wheels 1C, and a rear axle 1D connecting the right and left rear wheels 1C. The front wheels 1A are drivable and steerable. The rear wheels 1C are drivable. Right and left fenders 10 to cover the rear wheels 1C are provided laterally adjacent to the right and left sides of the driving section 9. On a rear side of a driving seat 91, rear end portions of the right and left fenders 10 are connected to each other by a connecting structure 10A extending along the vehicle body right-left direction. The connecting structure 10A is a metal frame and has high rigidity as compared with a resin material or the like.

A three-point link type link mechanism 13 to which a work device (not illustrated) such as a rotary tillage device is connected is provided at a rear portion of the vehicle body 2. The work device is driven by being connected to a PTO shaft (not illustrated) that outputs the power shifted by the transmission 11, and is able to be lifted and lowered by the link mechanism 13.

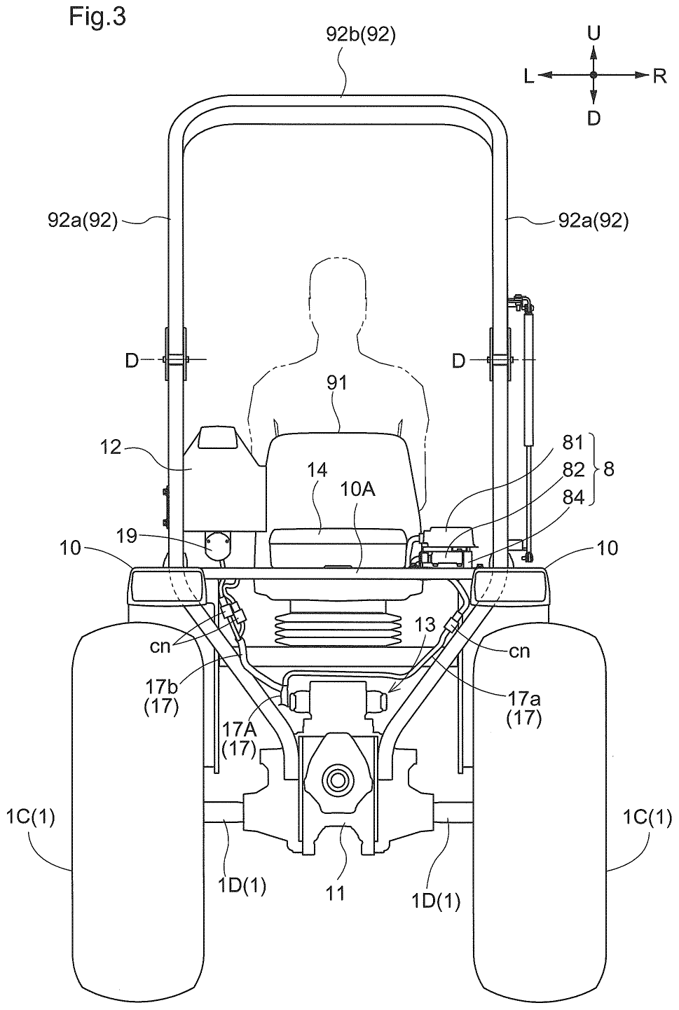

As illustrated in FIGS. 2 and 3, the vehicle body 2 is provided with a controller 18 and a communication module 8 that is connected to the controller 18 via a wire harness 17 and transmits information on the vehicle body 2 accumulated in a memory (not illustrated) of the controller 18 to the outside. The controller 18 includes a microprocessor including a central processing unit (CPU), an electrically erasable programmable read-only memory (EEPROM), and the like. For example, the controller 18 is an electric control unit (ECU). The controller 18 is configured or programmed to acquire signals output from various sensors provided in the traveling device 1 or the vehicle body 2 and controls the vehicle body 2. The communication module 8 acquires necessary information from the memory. The information on the vehicle body 2 acquired by the communication module 8 and transmitted to the outside includes, for example, a harvest amount per farm field, a state of soil, a vehicle speed, a road travel distance, a work travel distance, a work device driving time, a driving time of the electric motor 3, and the like.

An on-vehicle type fault diagnosis device (hereinafter, abbreviated as “OBD”) is included in the controller 18, and an OBD port 19 is connected to the controller 18 via the wire harness 17, and an external diagnosis device is able to be connected to the OBD port 19 to read a diagnostic trouble code (DTC).

As illustrated in FIGS. 1 and 2, the driving section 9 includes a steering handle 6 that steers the traveling device 1 (front wheels 1A), a handle post 7 that supports the steering handle 6, the driving seat 91 on which a driver sits, a roll-over protection structure (ROPS) 92 that is installed upright in the vicinity of a rear portion (seat back 91a) of the driving seat 91, and a floor portion 93 on which a foot of the driver sitting on the driving seat 91 is placed. The controller 18 is accommodated in the handle post 7. The driving section 9 is not provided with a cabin that covers the driving section 9.

In FIG. 1, a one-dot chain line A is a virtual line extending along a rear surface of the seat back 91a in the driving seat 91, and the ROPS 92 rise from a position forward of the rear surface of the seat back 91a. The ROPS 92 includes right and left vertical structures 92a that are installed upright on the fender 10, and a lateral structure 92b that is connected upper end portions of the right and left vertical structures 92a. A proximal end portion of the ROPS 92 is connected to the transmission 11. The ROPS 92 is rotatable about a rotation axis D extending in the vehicle body right-left direction at a use position D1 and a storage position D2. A two-dot chain line D2 in FIGS. 1 and 2 indicates the ROPS 92 at the storage position.

At the use position D1, the communication module 8 is provided at a position overlapping with the ROPS 92 in the vehicle body right-left direction. Accordingly, for example, even in a case where a side portion of the vehicle body 2 on a side comes into contact with an obstacle, it is possible to prevent the communication module 8 from coming into contact with the obstacle by the ROPS 92.

In the storage position D2, the lateral structure 92b of the ROPS 92 is located behind the communication module 8. Accordingly, for example, even in a case where the side portion of the vehicle body 2 on the rear side comes into contact with the obstacle, it is possible to prevent the communication module 8 from coming into contact with the obstacle by the ROPS 92.

In a rear portion of the driving section 9, the communication module 8, a toolbox 14 that accommodates a tool or the like, and a license plate 12 that displays a number plate or the like are provided in this order side by side in the vehicle body right-left direction in a plan view.

As illustrated in FIGS. 2 and 3, the communication module 8 is supported by the connecting structure 10A. The communication module 8 includes a communicator 81 configured or programmed to transmit information on the vehicle body 2 to the outside of the vehicle body, an information acquirer 82 that acquires information on the vehicle body 2, and a support structure 84.

The communication module 8 is provided at a position where at least a portion of the communication module 8 is exposed to the outside from the vehicle body 2. In addition, the communication module 8 is provided at a position where a portion of the vehicle body 2 does not overlap with the communication module 8 from above. Specifically, the communication module 8 is provided at a position that does not overlap with the ROPS 92 or the driving seat 91 in a plan view. In other words, a portion (the ROPS 92 or the driving seat 91) of the vehicle body 2 is not located above the communication module 8.

In FIG. 2, a broken line B is a virtual line extending forward and backward along an outer end portion of the communication module 8 in the vehicle body right-left direction, and a broken line C is a virtual line extending forward and backward along an outer end portion of the driving seat 91 in the vehicle body right-left direction. In the vehicle body right-left direction, the virtual line B is located outward of the vehicle body with respect to the virtual line C. That is, the outer end portion of the communication module 8 in the vehicle body right-left direction is located outward of the vehicle body with respect to the outer end portion of the driving seat 91 in the vehicle body right-left direction. Further, the communication module 8 is provided on the outer side of the vehicle body with respect to the driving seat 91 in the vehicle body right-left direction as a whole. In other words, the entire communication module 8 is provided outward of the vehicle body with respect to the driving seat 91 in the vehicle body right-left direction.

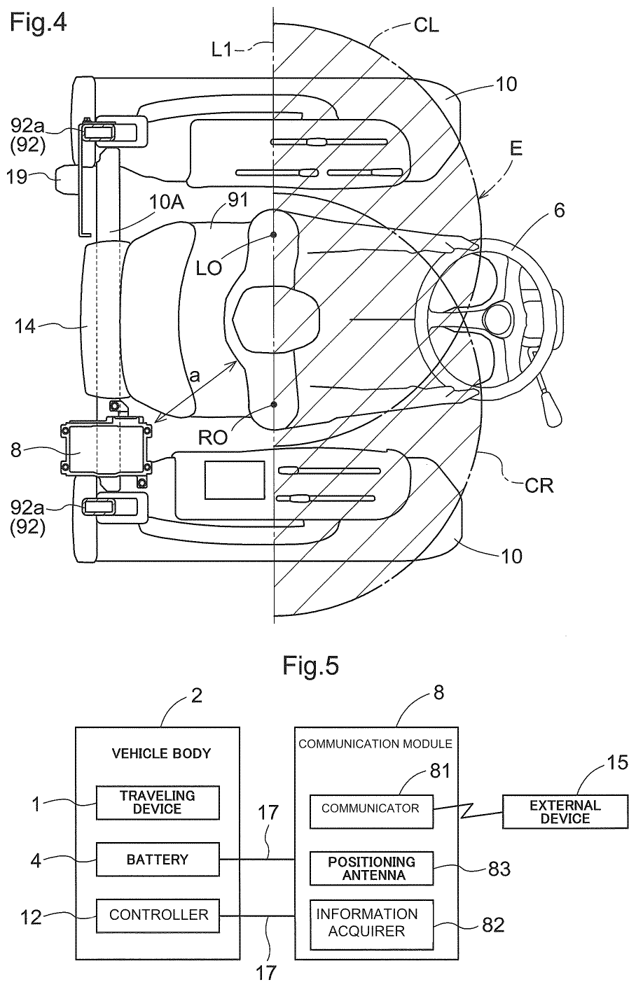

Since the communication module 8 generates electromagnetic waves, it is necessary to appropriately set a distance between the installation position of the communication module 8 and the driver. In FIG. 4, a distance a indicates a distance between the communication module 8 and the head of the driver. It is preferable that the distance a is greater than about 20 cm (centimeter), for example.

In addition, in FIG. 4, a region indicated by E is a maximum work range of the right and left arms of the driver on a horizontal plane. The maximum work range E indicates a range that is able to be reached by the hand of the driver in a plan view on the premise that the shoulder of the driver seated on the driving seat 91 is fixed. The maximum work range E is a region surrounded by a line L1 extending in the vehicle body right-left direction through centers RO and LO of the right and left shoulders of the driver in the vehicle body front-rear direction, a semicircle CR indicating a range reachable by the right hand with the right shoulder joint (center RO) of the driver as a center, and a semicircle CL indicating a range reachable by the left hand with the left shoulder joint (center LO) of the driver as a center. The communication module 8 is provided outside the range of the maximum work range E. That is, the communication module 8 is provided at a position that does not interfere with the range of work performed by the hand of the driver who is seated on the driving seat 91.

As illustrated in FIGS. 3 and 5, the communication module 8 is connected to the battery 4 and the controller 18 via the wire harness 17. The wire harness 17 is used for power supply from the battery 4 and signal communication between the communication module 8 and the controller 18.

The wire harness 17 includes a main harness 17A, a branch harness 17a extending to a communication module 8 side, and a branch harness 17b extending to an OBD port 19 side.

The main harness 17A extends from the controller 18 to a space between the transmission 11 and the connecting structure 10A below the driving section 9. The main harness 17A is branched into the branch harness 17a on the communication module 8 side and the branch harness 17b on the OBD port 19 side in the space between the transmission 11 and the connecting structure 10A. The wire harness 17 extending from the communication module 8 and the wire harness 17 extending from the OBD port 19 are attachable and detachable to and from the branch harness 17a and the branch harness 17b via a connector cn below the communication module 8 and the OBD port 19.

The communication module 8 transmits and receives information on the vehicle body 2 to and from an external device 15 via the Internet network or the like. The external device 15 is, for example, a server or the like installed in a manufacturer (manufacturing company) or a dealer (sales and maintenance company), and is provided at a remote location spaced away from the vehicle body 2.

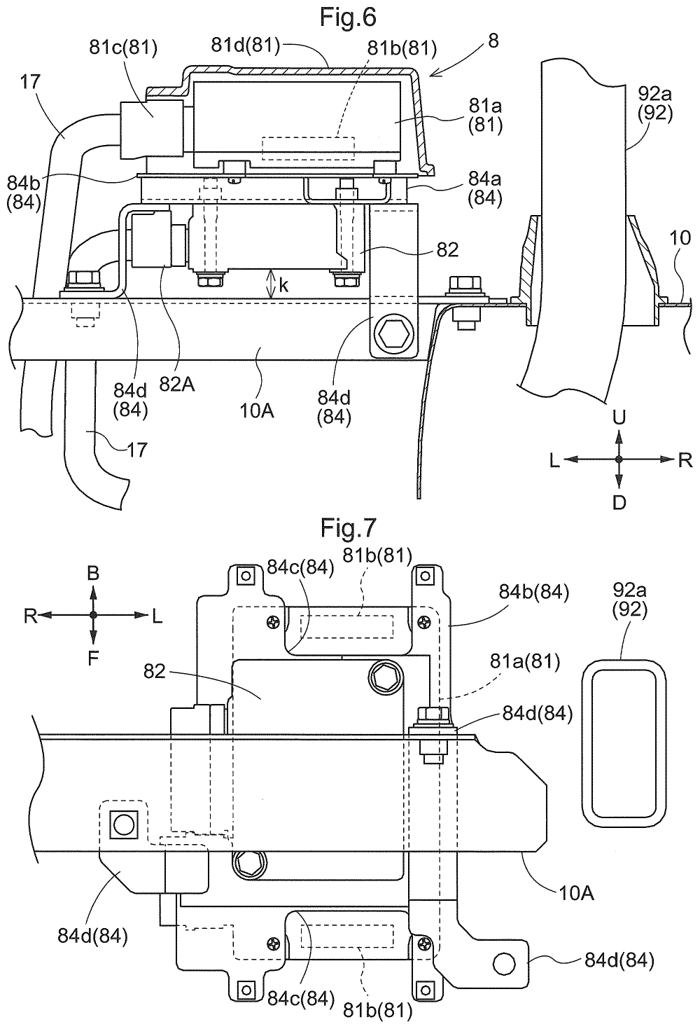

As illustrated in FIGS. 6 and 8, the support structure 84 includes an intermediate structure 84a, an attachment plate 84b, and a plurality of support legs 84d. The communication module 8 is supported by the support structure 84 at the connecting structure 10A.

The plurality of f support legs 84d are fixed to the connecting structure 10A and the fender 10 with bolts or the like. The right support leg 84d is formed by bending a metal plate material, and is connected to an upper surface of the right fender 10 and a side surface of the connecting structure 10A by bolts or the like. The left support leg 84d is formed by bending a metal plate material, and is connected to an upper surface of the connecting structure 10A by bolts or the like.

The intermediate structure 84a is provided between the support leg 84d and the attachment plate 84b. The intermediate structure 84a includes a steel plate formed in a U-shape and is connected to an upper portion of the support leg 84d. The information acquirer 82 is connected to a lower surface of the intermediate structure 84a by bolts or the like.

The attachment plate 84b includes a metal plate material and is connected to an upper portion of the intermediate structure 84a. The communicator 81 is connected to an upper surface of the attachment plate 84b by bolts or the like.

As illustrated in FIGS. 6 and 8, the communicator 81 includes a housing 81a, an antenna 81b, a connector portion 81c, and a cover structure 81d. The communicator 81 is a direct communication unit (DCU), for example.

The housing 81a is connected to the upper surface of the attachment plate 84b by bolts or the like. The housing 81a has a box shape including an upper surface, a side surface, and a lower surface. The antenna 81b is accommodated in the housing 81a.

The wire harness 17 is attachable and detachable to and from the connector portion 81c. The connector portion 81c is provided on a side surface of the housing 81a. The connector portion 81c faces the right-left center of the vehicle body 2. Accordingly, the wire harness 17 is attached and detached to and from a right-left center side of the vehicle body 2.

Therefore, it is possible to prevent a portion of the wire harness 17 from interfering with the rear wheel 1C or the like that is located outside the communication module 8 in the vehicle body right-left direction.

The cover structure 81d includes a synthetic resin and covers the upper surface and the side surface of the housing 81a from above. Accordingly, it is possible to prevent the housing 81a from being wet with rainwater or the like. The cover structure 81d is connected to the metal attachment plate 84b by bolts or the like.

As illustrated in FIGS. 6 and 8, the information acquirer 82 has a box shape including an upper surface, a side surface, and a lower surface, and a connector portion 82A to which the wire harness 17 is attachable and detachable is located on the side surface. The information acquirer 82 temporarily accumulates the information on the vehicle body 2 and transmits the information to the communicator 81. The information acquirer 82 is connected to an in-vehicle network such as a controller area network (CAN) or a flex ray via the wire harness 17.

The information acquirer 82 transmits the information on the vehicle body 2 to the communicator 81.

As illustrated in FIG. 5, a positioning antenna 83 is located inside the communicator 81, and measures the position of the vehicle body 2 by using a global positioning system (GPS) which is an example of a global navigation satellite system (GNSS). The positioning antenna 83 receives position information from the satellite and measures the position of the vehicle body 2 based on the received position information. The position information detected by the positioning antenna 83 is transmitted to the external device 15 by the communicator 81 as the information on the vehicle body 2 together with other information.

The position information measured by the positioning antenna 83 includes a positioning error caused by the position of the positioning antenna 83. The communication module 8 does not perform correction to eliminate the positioning error.

As illustrated in FIG. 6, the communicator 81 vertically overlaps with the information acquirer 82 while being located above the information acquirer 82. The communicator 81 is fixed to an upper portion of the intermediate structure 84a of the support structure 84, and the information acquirer 82 is fixed to a lower portion of the intermediate structure 84a of the support structure 84. That is, the information acquirer 82 is provided at a position facing the communicator 81 with the support structure 84 interposed therebetween. The support structure 84 provides an interval k between the communication module 8 and the connecting structure 10A. Accordingly, a configuration is provided such that the air is able to flow between the communication module 8 and the connecting structure 10A, and an increase in temperature of the communication module 8 is able to be reduced or prevented.

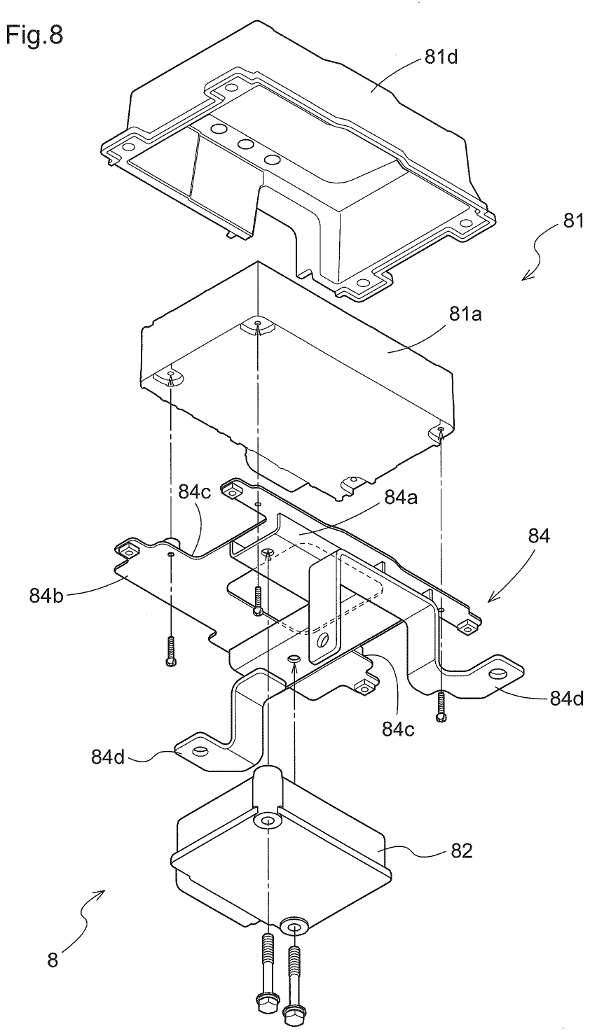

FIG. 7 is a bottom view illustrating an attachment structure of the communication module 8. As illustrated in FIG. 7, the antenna 81b is provided at a position that does not overlap with the connecting structure 10A and the support structure 84 in a planar manner. Specifically, the attachment plate 84b is includes a recess portion 84c, the antenna 81b is provided above the recess portion 84c, and the attachment plate 84b is configured not to be located below the antenna 81b. Therefore, even in a case where the connecting structure 10A or the attachment plate 84b is made of metal, the communication state of the antenna 81b is less likely to be affected by the connecting structure 10A or the attachment plate 84b.

The present invention may be configured as the following other example embodiments in addition to the above-described example embodiments. In the following description of the other example embodiments, the same configurations as those of the above example embodiments are denoted by the same reference numerals and signs as those of the above example embodiments.

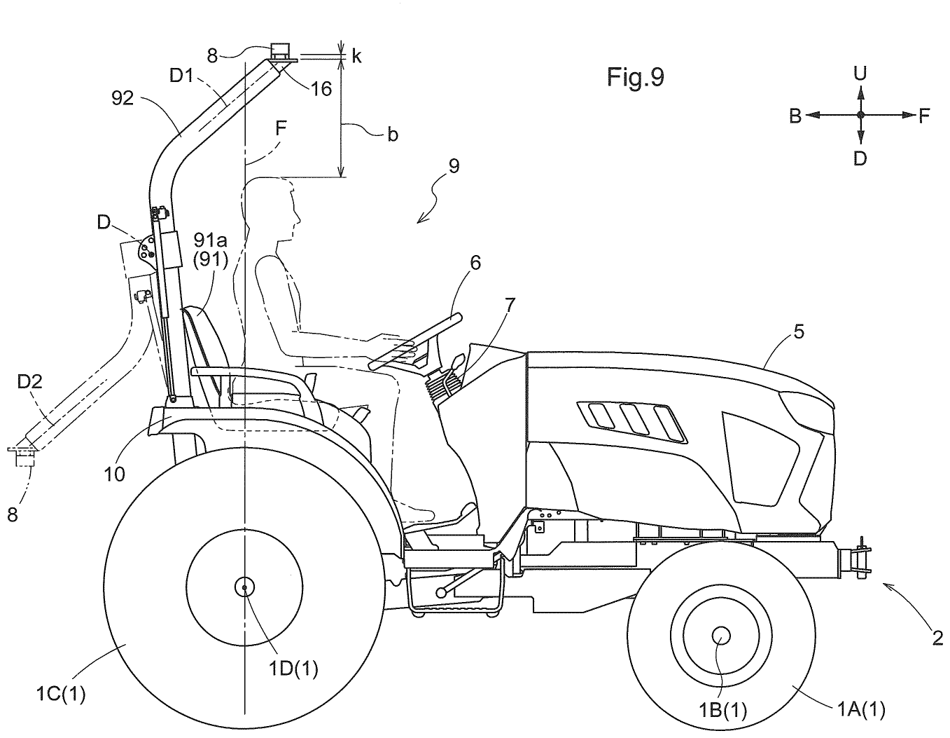

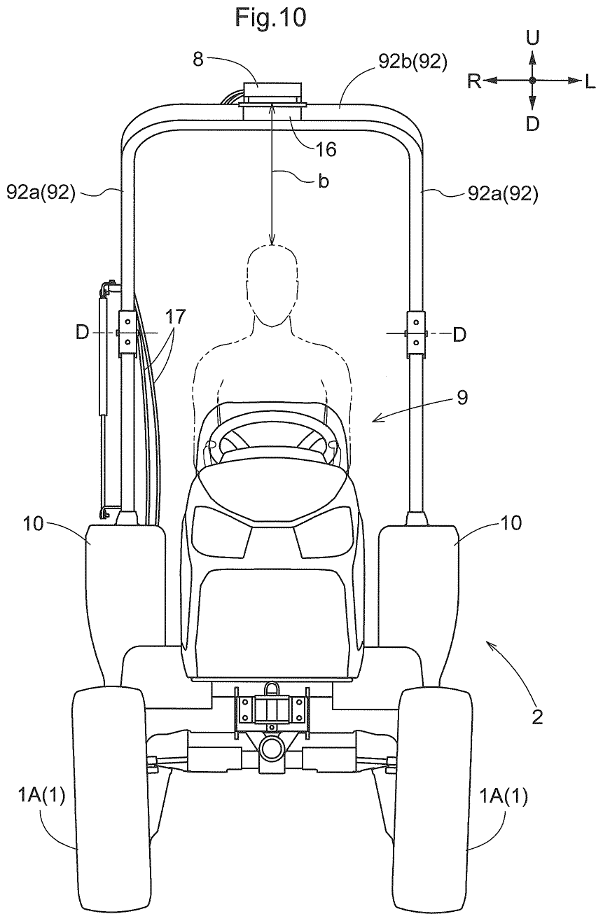

As illustrated in FIGS. 9 and 10, the communication module 8 may be provided on the lateral structure 92b of the ROPS 92. Specifically, the communication module 8 is attached to the lateral structure 92b by an attachment bracket 16. In addition, the communication module 8 is provided at a right-left center position of the lateral structure 92b. As in the above-described example embodiments, the interval k is provided between the communication module 8 and the attachment bracket 16. In addition, as in the above-described example embodiments, it is preferable that the distance b between the head of the driver and the communication module 8 is greater than about 20 cm, for example.

A one-dot chain line F in FIG. 9 is a virtual line that passes through the axis center of the rear axle 1D and extends in the up-down direction of the vehicle body 2. The communication module 8 is provided forward of the virtual line F in the vehicle body front-rear direction. That is, the communication module 8 is provided forward of the vehicle body 2 with respect to the rear axle 1D.

A two-dot chain line D2 in FIG. 9 indicates the ROPS 92 in the storage position. As illustrated in FIG. 9, the lateral structure 92b is provided at a height that is equal or substantially equal to an upper end portion of the rear wheel 1C at the storage position D2. Accordingly, the communication module 8 is able to be moved to a height at which maintenance is easily performed.

The wire harness 17 connected to the communication module 8 is arranged to pass through the inside of the ROPS 92 from an opening (not illustrated) provided in the ROPS 92 or the like. The wire harness 17 is led out to the outside of the ROPS 92 from an opening (not illustrated) or the like provided above the rotation axis D.

The present invention is not limited to this, and the wire harness 17 may be arranged along the outer surface of the ROPS 92 without passing through the inside of the ROPS 92. In this case, the outer surface of the ROPS 92 may be the side surface of the vehicle body 2 on the right-left center side in the ROPS 92. Accordingly, the wire harness 17 does not interfere with the rear wheel 1C or the like located on the outer side of the vehicle body with respect to the ROPS 92 in the vehicle body right-left direction. The communication module 8 may be provided in the vertical structure 92a instead of the lateral structure 92b. The ROPS 92 may be installed upright in the vicinity of the front portion of the driving section 9 without being installed upright in the vicinity of the rear portion (driving seat 91) of the driving section 9.

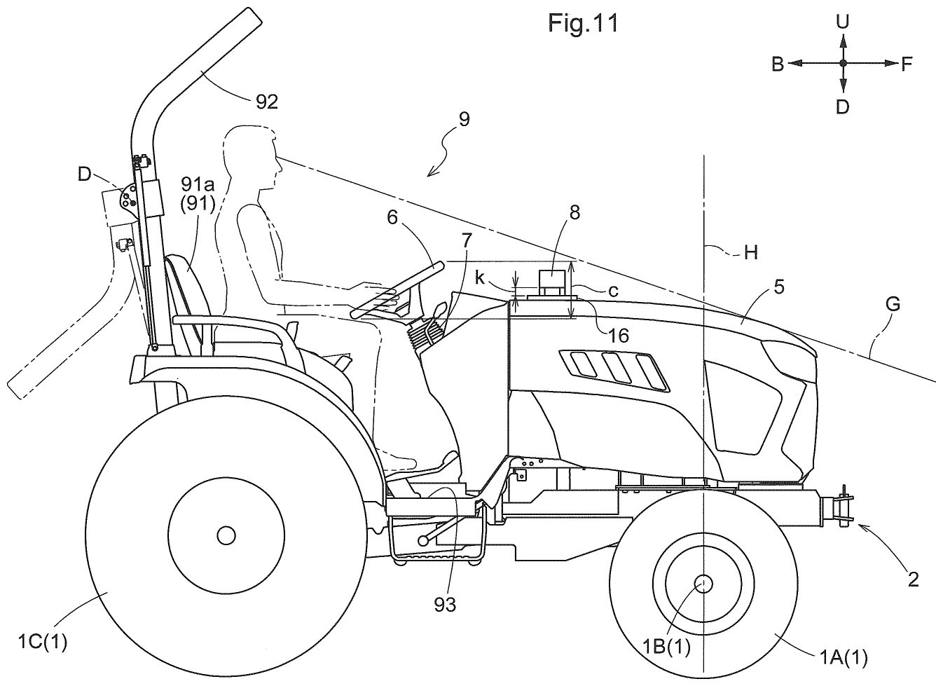

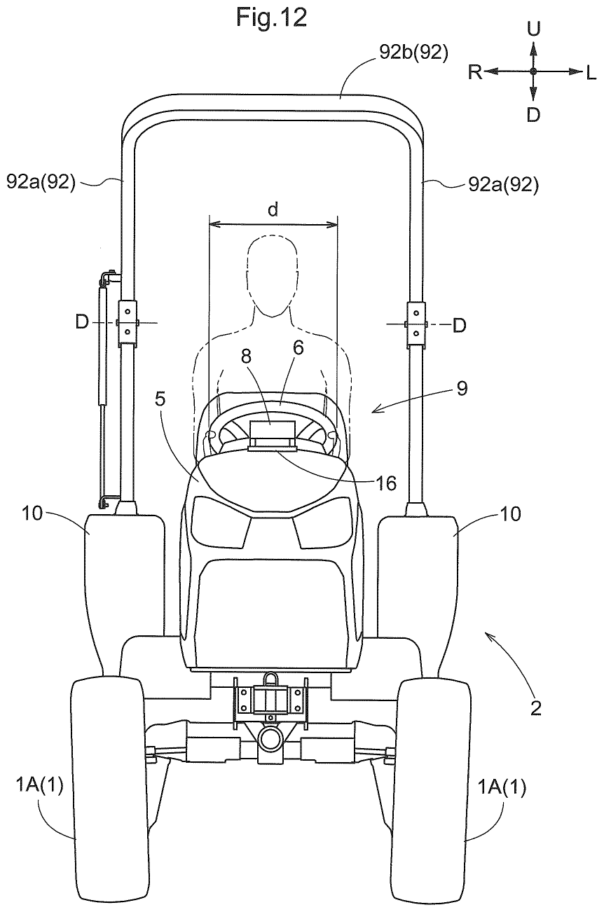

As illustrated in FIGS. 11 and 12, the communication module 8 may be provided in the hood 5. Specifically, the communication module 8 is attached to the upper surface of the hood 5 by the attachment bracket 16. The communication module 8 is provided at a position of the right-left center of the hood 5. As in the above-described example embodiments, the interval k is provided between the communication module 8 and the attachment bracket 16. A distance c in FIG. 11 is a distance between an upper end portion and a lower end portion of the steering handle 6. The communication module 8 is positioned to be within a range of the distance c. That is, the communication module 8 is located below the upper end portion of the steering handle 6.

A one-dot chain line G in FIG. 11 is a virtual line indicating a field of view of the driver seated on the driving seat 91. The communication module 8 is located below the virtual line G. Accordingly, the communication module 8 does not block the field of view of the driver.

A one-dot chain line H in FIG. 11 is a virtual line extending in the up-down direction of the vehicle body 2 through the axis center of the front axle 1B. The communication module 8 is provided rearward of the vehicle body with respect to the virtual line H. That is, the communication module 8 is provided rearward of the vehicle body 2 with respect to the front axle 1B. Here, the communication module 8 is more likely to obstruct the field of view of the driver as the communication module 8 is provided closer to the front side of the hood 5 in the vehicle body front-rear direction. That is, the communication module 8 is able to be provided at a position where the field of view of the driver is not obstructed.

A distance d in FIG. 12 indicates a distance between right and left end portions of the steering handle 6. The communication module 8 is positioned to be within a range of the distance d. That is, the communication module 8 is provided at a position of the right-left center of the hood 5 with respect to the right and left end portions of the steering handle 6. As a result, a right-left width of the communication module 8 is not excessively large, and the communication module 8 does not obstruct the field of view of the driver.

Although not particularly illustrated, the ROPS 92 may include a connection frame that connects up-down middle portions of the right and left vertical structures 92a to the ROPS 92 below the lateral structure 92b, and the communication module 8 may be provided in the connection frame.

Although not particularly illustrated, the communication module 8 may be provided on the upper surface of the floor portion 93 while the other structures are not located above the communication module 8.

Although not particularly illustrated, the communication module 8 may be provided on the handle post 7 while the other structures are not located above the communication module 8.

Although not particularly illustrated, the communication module 8 may be provided on the upper surface of the fender 10 while the other structures are not located above the communication module 8.

Although not particularly illustrated, the work vehicle may be a cabin machine including a cabin that covers the driving section 9. In this case, it is preferable that the communication module 8 is provided in a roof portion of the cabin.

The external device 15 is not limited to the one illustrated in the above-described example embodiments, and may be a tablet PC, a smartphone, or a mobile phone located in the driving section 9 as long as wireless communication with the communication module 8 is possible.

In the above-described example embodiments, an example in which the entire information acquirer 82 overlaps with the communicator 81 in a planar manner is illustrated. The present invention is not limited to this, and a configuration in which a portion of the information acquirer 82 overlaps with the communicator 81 in a planar manner or a configuration in which the information acquirer 82 does not overlap with the communicator 81 in a planar manner may be adopted.

In the above-described example embodiments, electric tractors that travel using the battery 4 and the electric motor 3 is disclosed. The present invention is not limited to this, and a tractor including an engine (not illustrated) may be used.

In the above-described example embodiments, the tractor that travels with driving by the driver is disclosed. The present invention is not limited to this, the work vehicle may be a tractor that is able to travel without a driver.

In the above-described example embodiments, the harvest amount per farm field, the state of soil, the vehicle speed, the road travel distance, the work travel distance, the work device driving time, the driving time of the electric motor 3, and the position information are exemplified as the information on the vehicle body 2 handled by the communication module 8. However, the present invention is not limited to this example. The communication module 8 may be in a state of not transmitting the position information as the information on the vehicle body 2.

The configurations disclosed in the above-described example embodiments (including the other example embodiments, the same applies hereinafter) are able to be applied in combination with the configurations disclosed in other example embodiments as long as there is no contradiction, and the example embodiments disclosed in the present specification are merely examples, and the example embodiments of the present invention are not limited thereto and are able to be appropriately modified without departing from the scope of the present invention.

Example embodiments of the present invention are not limited to the tractor, and are able to be applied to a rice transplanter, a combine harvester, a harvester other than combine harvester, a grass cutter, a construction machine, and the like as long as the work vehicles include the communication module that transmits information on the vehicle body to the outside.

The above and other elements, features, steps, characteristics and advantages of the present invention will become more apparent from the following detailed description of the example embodiments with reference to the attached drawings.

What is claimed is:

1. A work vehicle, comprising:
a traveling device;
a vehicle body supported by the traveling device; and
a communication module configured or programmed to transmit information on the vehicle body to an outside; wherein
a portion of the communication module is exposed from the vehicle body to the outside.

2. The work vehicle according to claim 1, wherein the communication module and the vehicle body do not overlap each other as viewed from above.

3. The work vehicle according to claim 1, wherein
the vehicle body includes a driving section including a driving seat; and
the communication module is provided rearward of the driving seat.

4. The work vehicle according to claim 3, wherein an outer end portion of the communication module is located outward of an outer end portion of the driving seat in a vehicle body right-left direction.

5. The work vehicle according to claim 3, further comprising:
a controller provided in the driving section; and
a wire harness configured to connect the controller and the communication module; wherein
the controller is located forward of the communication module;
the wire harness extends from the controller to the rear side of the driving seat below the driving section, and is connected to the communication module;
a connector is provided in a portion of the wire harness that is located rearward of the driving section, and the wire harness is separable into a portion on a controller side and a portion on a communication module side.

6. The work vehicle according to claim 1, wherein
the vehicle body includes:
a driving section; and
a ROPS surrounding the driving section;
the ROPS includes:
right and left vertical structures installed upright at both right and left end portions of the driving section; and
a lateral structure connected to upper end portions of the right and left vertical structures; wherein
the communication module is provided between the right and left vertical structures.

7. The work vehicle according to claim 1, wherein
the vehicle body includes:
right and left fenders covering the traveling device; and
a connecting structure connected to the right and left fenders; wherein
the communication module is provided on the connecting structure.

8. The work vehicle according to claim 7, wherein
the communication module includes an antenna configured to transmit the information on the vehicle body to the outside; and
the antenna and the connecting structure do not overlap each other in a planar manner.

9. The work vehicle according to claim 1, wherein
the vehicle body includes:
a driving section; and
a ROPS surrounding the driving section;
the ROPS includes:
right and left vertical structures installed upright at both right and left end portions of the driving section; and
a lateral structure connected to upper end portions of the right and left vertical structures; wherein
the communication module is provided on the lateral structure.

10. The work vehicle according to claim 1, wherein
the vehicle body includes a driving section including a driving seat; and
the communication module is provided at a position not interfering with a range of work performed by a hand of a driver seated on the driving seat.

11. The work vehicle according to claim 1, wherein
the communication module includes:
an information acquirer configured or programmed to acquire the information on the vehicle body; and
a communicator configured or programmed to transmit the information on the vehicle body to the outside; wherein
the communicator vertically overlaps with the information acquirer and is located above the information acquirer.
